(19) United States
(12) Patent Application Publication
(10) Pub. No.: US 2010/0179915 A1
(43) Pub. Date: Jul. 15, 2010

(54) APPARATUS, SYSTEM, AND METHOD FOR AGGREGATING A PLURALITY OF FEEDS

(75) Inventor: Denilson Nastacio, Apex, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/353,163

(22) Filed: Jan. 13, 2009

(51) Int. Cl. G06Q 99/00; G06F 17/30; G06F 7/06

(52) U.S. Cl. 705/319; 707/E17.109; 707/E17.048

(57) ABSTRACT

An apparatus, system, and method are disclosed for aggregating a plurality of feeds automatically without explicitly designing or developing an aggregated feed. In one embodiment, a collaboration module defines a collaboration group of one or more members with each member having an online relationship to each other. A definition module defines a feed tag protocol that members of the collaboration group agree to follow for marking content feeds. An aggregation module receives an aggregated feed request and retrieves a set of feeds tagged by members of the collaboration group that satisfy the aggregated feed request. The aggregation module also generates a single aggregated feed based on the set of feeds that satisfy the feed tag protocol.

### FIELD OF THE INVENTION

This invention relates to digital content aggregation and more particularly relates to aggregating a plurality of web feed sources into a single aggregated feed.

### BACKGROUND

### Description of the Related Art

A web feed is a method of delivering content, such as news, images, data or other web related content to many users. Feeds allow users to determine when a website has added new content without physically visiting the website. The feeds themselves are ordinarily published as a text file including a headline of an article or other content item. The feeds also include a brief summary of the headline with a link to the full article. If a user is interested in the summary, the user follows the link to the full article to view the rest of the content. Feeds may be general in that they do not deal with any specific topic. Other feeds may be limited to content items dealing with a specific topic. Web feeds are syndicated across a network in a variety of formats. Popular syndication formats include Really Simple Syndication (RSS) and ATOM.

Web feeds are published as Extensible Markup Language (XML) which is generally awkward or impossible to read by humans. Therefore, to read or view a feed, the user uses a feed reader to subscribe to the feeds. The feed reader is configured to parse the web feed and render the feed in a format readable by humans. The feed reader regularly checks the feed source for updated content. In this manner a user is kept informed of changes to a website or new information posted to a website without visiting each website to see if anything is new.

As a user finds an interesting or relevant website or web feed the user adds the feed to the feed reader. Over time the user may subscribe to many web feeds with each feed dealing with a particular subject matter or topic. Additionally, feeds that provide inaccurate or irrelevant information may be weeded out of a users feed subscriptions. This acquisition of feed subscriptions and identification of relevant or important feeds may require a substantial amount of time and effort. The careful maintenance of a set of feed subscriptions comprises valuable intellectual property which others may find valuable.

Certain content providers allow a user to compose a web feed using proprietary controls. The user composes a feed by select portions of that provider's content to include in the feed. However, the user is restricted to content from the same provider and cannot add external content.

With the proliferation of online social networking sites such as MySpace and Facebook users can associate contacts or “friends” with user profiles to enable sending messages and media to be sent back and forth. Often, users have dozens if not hundreds of friends in their online social network. These friends may publish several media content items per day or per week. However, there are no social networking sites that allow web feed aggregation.

Independent vendors, without ties to content providers, allow users to compose an aggregated feed and export the results as a single feed. Unfortunately, the users that compose the aggregated feed are forced to learn how to use the development environment for composing the aggregated feed. In addition, subscribers to this aggregated feed are unaware of the individual feeds that makeup the aggregated feed. Further, users cannot add additional feeds to the aggregated feed. Thus social collaboration is diminished in this solution.

### BRIEF SUMMARY

From the foregoing discussion, it should be apparent that a need exists for an apparatus, system, and method that leverages the social networking services as an indicator of feed content for aggregation. Beneficially, such an apparatus, system, and method would share aggregated content with other users and allow a user to consolidate content from multiple content providers.

The present invention has been developed in response to the present state of the art, and in particular, in response to the problems and needs in the art that have not yet been fully solved by currently available feed aggregators. Accordingly, the present invention has been developed to provide an apparatus, system, and method for aggregating a plurality of feeds that overcome many or all of the above-discussed shortcomings in the art.

The apparatus to aggregate a plurality of feeds is provided with a plurality of modules configured to functionally execute the necessary steps of feed aggregation. These modules in the described embodiments include a collaboration module, a definition module and a aggregation module. The collaboration module defines a collaboration group of one or more members with each member having an online relationship to each other. The definition module defines a feed tag protocol that members of the collaboration group agree to follow for marking content feeds. The aggregation module receives an aggregated feed request and retrieves a set of feeds tagged by members of the collaboration group that satisfy the feed tag protocol. The aggregation module generates a single aggregated feed based on the set of feeds. The single aggregated feed is defined by a set of tags that satisfy the feed tag protocol.

In certain embodiments the apparatus also includes a feed read module that communicates the aggregated feed request to the aggregation module such that the single aggregated feed incorporates feeds tagged by members of the collaboration group since a last aggregated feed request.

The apparatus, in one embodiment, is configured to condition membership in the collaboration group upon a member having one or more predefined characteristics. In certain embodiments the predefined characteristic is the member belonging to an online social network.

In a further embodiment, the apparatus may include a subscriber module that defines a subscriber group of users subscribing to the single aggregated feed. The subscriber module also manages subscriptions for users of the subscriber group. In one embodiment the users of the subscriber group belong to the same social network.

The apparatus, in another embodiment, includes a feed tagging module that associates a feed tag with a feed identified by a member of the collaboration group. The feed tag is assigned by the member in accordance with the feed tag protocol.

In one embodiment the apparatus includes a storage module that stores the association between the feed and the feed tag. The association is stored in a database such that the aggregation module retrieves the feed in response to a subsequent aggregated feed request.

A computer program product is also presented to aggregate a plurality of web feed sources. The operations of the computer program product include defining a collaboration group of one or more members with each member having an online relationship to each other. The operations of the computer program product also include defining a feed tag protocol that members of the collaboration group have agreed to follow for marking the feeds. The operations may also include receiving an aggregated feed request and retrieving a set of feeds tagged by members of the collaboration group that satisfy the aggregated feed request. In one embodiment the operations of the computer program product also include generating a single aggregated feed based on the set of feeds. The single aggregated feed is defined by a set of tags that satisfy the feed tag protocol.

A system for aggregating a plurality of feeds is also presented. The system includes a network, a client and a server. The network communicates data between a plurality of devices. The client is in communication with the network and includes a feed tagging module that associates a feed tag with a feed. The feed tag is assigned by a member of a collaboration group in accordance with a feed tag protocol. The server is also in communication with the network and includes a collaboration module, a definition module, an aggregation module and a feed read module. The collaboration module defines the collaboration group of one or more members. Each member of the collaboration group has an online relationship to each other. The definition module defines the feed tag protocol that members of the collaboration group agree to follow for marking feeds. The aggregation module receives an aggregated feed request and retrieves a set of feeds tagged by members of the collaboration group that satisfy the aggregated feed request. The aggregation module also generates a single aggregated feed based on the set of feeds. The single aggregated feed is defined by a set of tags that satisfy the feed tag protocol. The feed read module reads the single aggregated feed in response to an aggregated feed request from a user.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for aggregating a plurality of feeds in accordance with the present invention;

FIG. 2 is a schematic block diagram illustrating one embodiment of the collaboration module of FIG. 1 in accordance with the present invention;

FIG. 3 is a schematic block diagram illustrating one embodiment of the definition module of FIG. 1 in accordance with the present invention;

FIG. 4 is a schematic block diagram illustrating one embodiment of the client of FIG. 1 in accordance with the present invention;

FIG. 5 is a schematic block diagram illustrating one embodiment of a system for aggregating a plurality of feeds in accordance with the present invention;

FIG. 6 is a schematic flow chart diagram illustrating one embodiment of a method for aggregating a plurality of feeds in accordance with the present invention; and

FIG. 7 is a schematic flow chart diagram illustrating one embodiment of a method for aggregating a plurality of feeds in accordance with the present invention.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, or semiconductor system, apparatus, device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

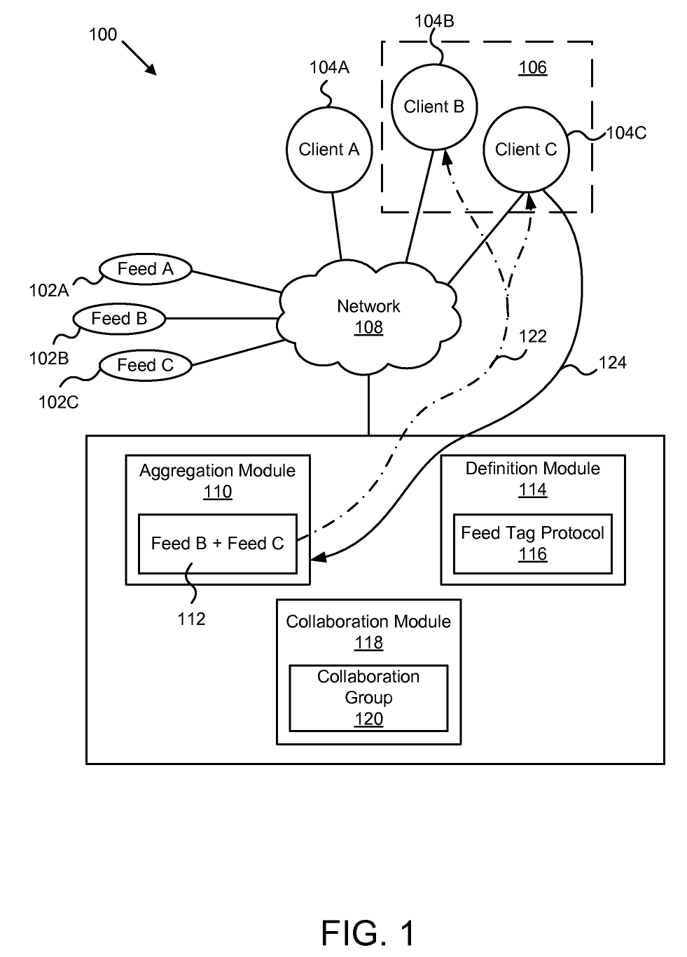

FIG. 1 illustrates a system 100 for aggregating a plurality of web feeds 102A-102C according to one embodiment of the current invention. The system 100 includes a plurality of clients 104A-104C, an online relationship 106 between clients 104B and 104C, a network 108, an aggregation module 110, an aggregated feed 112, a definition module 114, a feed tag protocol 116, a collaboration module 118, and collaboration group 120.

Users of the system 100 use clients 104A-104C (generally 104) to form online relationships such as the online relationship 106 depicted between client 104B and client 104C. A client 104 is a computing apparatus comprising electronic hardware, electronic software and/or a combination of hardware and software. The client 104 is configured to communicate with servers and other devices connected to the network 108 to locate, access, and read feeds 102 as well as other web-based content including websites, audio content, video content, XML/HTML content and the like. In certain embodiments the clients 104 include a personal computer, hand held computer, telephone with data access or any other data transferring device capable of communicating and sending and receiving data over the network 108. An online relationship 106 is an association between users that own or operate the clients 104. This association may be based on a virtual association or actual relationship and may be referred to as a social relationship such that two or more users having the same online relationship are referred to as members of a social network. The online relationship 106 may include two or more clients 104 that communicate with one another regarding a particular subject. In one embodiment the online relationship 106 includes any online friendship, club, group, organization or other network of users. In certain embodiments the online relationship 106 may comprise an online social network consisting of many clients 104 such as clients 104A-104C. As illustrated in FIG. 1, in certain embodiments clients 104, such as client 104A, may be excluded from the online relationship 106 based on some predefined criteria. For example, in one embodiment registration in a social network may be required for a user of the client 104 to be included in the online relationship 106. In other embodiments the predefined criteria may be more strict than simple registration such as a subscription or passing a test to be included in the online relationship 106.

Clients 104 may comprise personal computers, a portable device including a cell phone, or any other electronic device capable of interfacing either directly or indirectly with the network 108. Clients 104 are configured to receive information, such as a web page, a web feed, email or other digital content from the network 108 and send information including email messages, message board postings, etc. to network 108. While the embodiment illustrated in FIG. 1 shows three clients, one skilled in the art will recognize that the system 100 may include thousands of clients 104.

Similarly, the illustration shown in FIG. 1 depicts three web feeds or feeds 102A-102C (generally 102) associated with network 108. However, one skilled in the art will recognize that system 100 may include thousands of feeds 102 in certain embodiments. A feed 102 is a data format used to provide users frequently updated content. Ordinarily, feeds 102 are made up of individual content items which are regularly updated. A content provider updates the feed 102 with new content as the new content is either created or discovered. Content may include text files, HTML pages, pictures, audio or any other digital content. In one embodiments the feeds 102 only include a brief summary of the content with a link to the entire document, picture, audio file or other digital content. In certain embodiments the content items that make up each individual feed 102 may be related to a common subject matter. In other embodiments the content items making up feeds 102 may be unrelated. In one embodiment, the feed 102 is an RSS feed or an Atom Syndication Format feed or a feed published according to the Atom Publishing Protocol (AtomPub or APP). One skilled in the art will recognize that web feeds 102 may include other web feed formats.

In one embodiment the network 108 includes a private network such as a Local Area Network (LAN) or Wide Area Network (WAN). In another embodiment the network 108 includes a public network such as the internet. In certain embodiments the system 100 is coupled to both a private network and a public network.

The definition module 114 defines a feed tag protocol 116 for tagging feeds 102. The feed tag protocol 116 is a standard predefined procedure for adding descriptive tags to feeds 102 to identify the content of the feeds 102. For example, in one embodiment the feed tag protocol 116 includes an agreement to use a particular predefined set of feed tags to identify the subject matter of a particular feed 102. In another embodiment the feed tag protocol 116 may include a predefined format, code, or other identification method for identifying the subject matter of a feed 102. In certain embodiments the feed tag protocol 116 is a specific term used to describe each feed 102. In other embodiments the feed tag protocol 116 is an agreed upon format for tagging feeds 102. The agreed upon format may include using acronyms to describe the subject matter of the feeds 102, using synonyms to describe the subject matter of the feeds 102, using a hierarchy of terms to describe the subject matter of the feeds 102, or any other predetermined protocol used by two or more members of a collaboration group 120 to identify the subject matter of the feeds 102. The use of a predefined feed tag protocol 116 allows users of the system 100 to define feeds that are to be included in the aggregated feed 112. Thus, users of the system 100 can more readily identify feeds 102 pertaining to a particular topic

Users of system 100 apply tags to feeds 102 (associate tags with feeds 102) according to the procedure identified by the feed tag protocol 116. For example, where the feed tags are predefined, the users of system 100 may select the feed tag that most closely describes the content of the feed 102. In another embodiment, a user may describe the content of the feed 102 in accordance with the feed tag protocol 116 by using an acronym accepted for the subject matter. One skilled in the art will recognize that there are many procedures that may be used to assure the users tag the feeds 102 according to a common feed tag protocol 116.

In one embodiment, the feed tag protocol 116 comprises a predefined set of tags and/or rules that the collaboration group members agree will identify feeds 102 for use in the aggregated feed. The feed tag protocol 116 may be predefined and made available for use by collaboration group members. Alternatively, or in addition, the collaboration group members may work together to define the feed tag protocol 116. In certain embodiments, a collaboration group leader may define the feed tag protocol 116 that all members of the collaboration group use. In addition, the collaboration group leader may be required to approve additions of new members to the collaboration group.

A feed tag protocol 116 may be as simple as a particular word or phrase. Alternatively, the feed tag protocol may be complex and include a set of accepted terms/words for use in identifying feeds 102 for the aggregated feed 102.

In one embodiment, the definition module 114 defines a one or more relationships between tags in the set of tags for the feed tag protocol 116. The relationship may comprise a basic set membership relationship meaning if a tag (such as a key word, acronym, or term) is listed as a member of the set of tags for the feed tag protocol 116 then feeds 102 that are marked by tags in the set are to be included in the aggregated feed. Alternatively, or in addition, the relationship may comprise a hierarchical relationship meaning that combinations of tags in a hierarchical relationship to each other in the feed tag protocol 116 must match a hierarchical structure of tags associated with a feed 102 before that feed 102 is included in the aggregated feed. Alternatively, or in addition, the relationship may comprise a grammatical relationship meaning that tags in the feed tag protocol all share a common grammatical relationship. For example, all the tags of the feed tag protocol 116, may relate to each other because they are each known synonyms of each other. In such a tag protocol 116 a set of relevant tags may be defined and a rule defined that causes that feeds 102 have the same grammatical relationship to the relevant tags (i.e. synonyms) will be included in the aggregated feed.

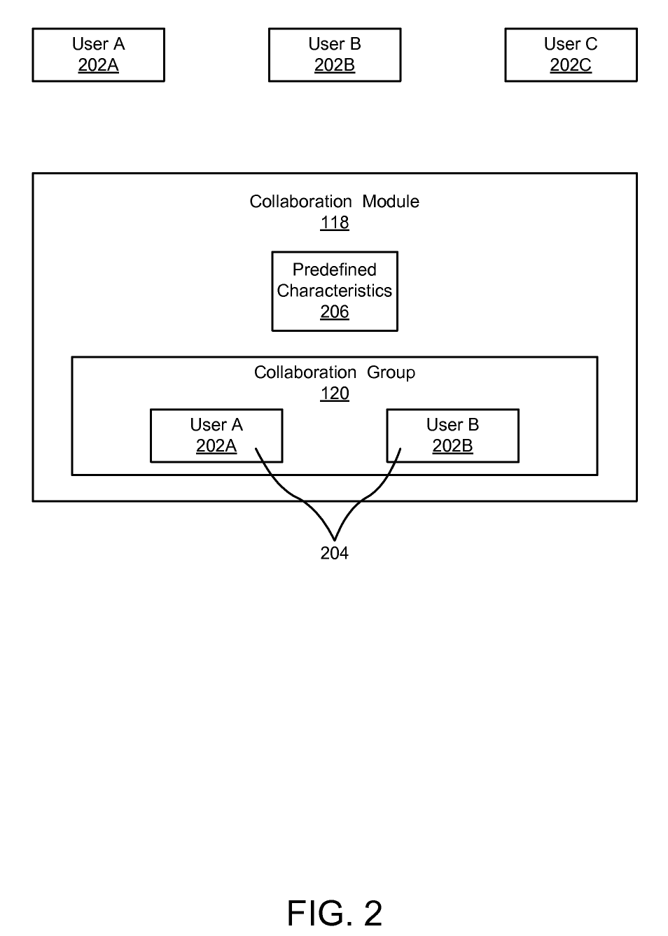

As discussed in further detail with reference to FIG. 2, the collaboration module 118 defines a collaboration group 120. A collaboration group 120 is one or more members that each have an online relationship 106 to each other. In one embodiment, the collaboration group 120 includes experts in a particular subject matter that work together to identify and tag feeds 102 containing subject matter relevant to the member's expertise. In certain embodiments the online relationship 106 includes being member of an online social network. In another embodiment the online relationship 106 includes any online friendship, club, group, organization or other network of users. In certain embodiments the online relationship 106 may also include any online association between two or more members of the collaboration group 120 Members of the collaboration group 120 agree to follow the feed tag protocol 116 defined by the definition module 114.

The aggregation module 110 retrieves a set of feeds 102 that have been tagged by members of the collaboration group 120. The aggregation module 110 aggregates the set of feeds 102 into a single aggregated feed 112. In the embodiment illustrated in FIG. 1, feed B 102B and feed C 102C are aggregated into aggregated feed 112 as a result of an aggregated feed request 124 from a client 104.

An aggregated feed tag request 124 is a request for the set of feeds 102 satisfying the aggregated feed tag protocol 116. In one embodiment, the aggregated feed tag request 124 comprises a unique Universal Resource Indicator/Locator (URI/URL). In another embodiment, the aggregated feed tag request 124 comprises a unique identifier that maps to a Universal Resource Indicator/Locator (URI/URL).

The aggregated feed request 124 includes a request from a client 104 in which the client 104 requests feeds 102 that satisfy the feed tag protocol 116. The aggregated feed request 124 is communicated to the aggregation module 110 through the network 108. The aggregation module 110 interprets the aggregated feed tag request 124. Once the aggregation module 110 in the embodiment of FIG. 1 receives the aggregated feed request, the aggregation module 110 identifies feed B 102B and feed C 102C as tagged in accordance with the feed tag protocol 116 and satisfying the aggregated feed request 124. Consequently, feed B 102B and feed C 102C are combined to form the aggregated feed 112. One of skill in the art will recognize that additional feeds may be included in the aggregated feed 112 if the additional feeds are tagged according to the tag or tags identified in the feed tag protocol 116. Advantageously, the aggregation module 110 dynamically determines the feeds 102 to include in the aggregated feed 112. User programming or defining of the aggregated feed 112 is not needed.

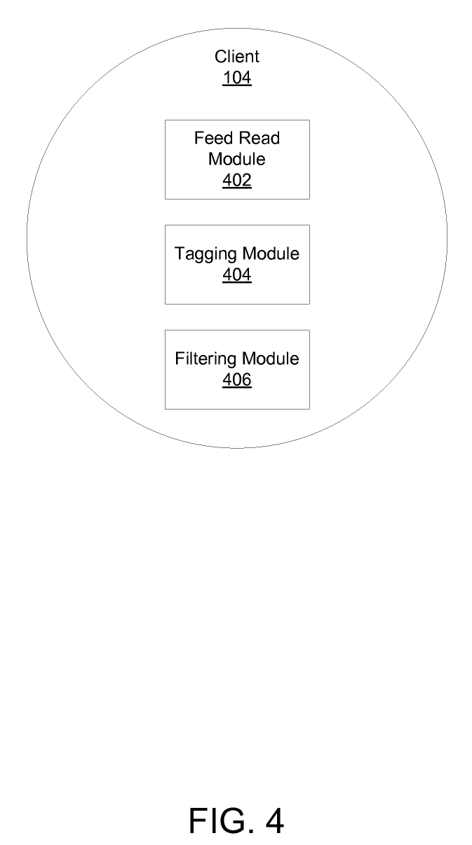

As discussed in further detail with reference to FIG. 4, in certain embodiments a tagging module 404 allows users of the system 100 to add feed tags to individual feeds 102. In one embodiment, the tagging module 404 includes a web browser plug-in configured to allow a client to add descriptive tags to the feed 102. In one embodiment the user adds the tag to the entire feed 102. In another embodiment the user adds the tag to individual content items within the feed 102. One of skill in the art will recognize that in certain embodiments the tagging module 404 may be configured to allow a user to tag either an entire feed 102 or an individual content item within the feed 102.

Those of skill in the art will recognize that the tagging module 102 may be embodied in other forms other than a web browser plug-in, for example, in certain embodiments a feed reading module (402 of FIG. 4) includes a feed reader configured to read feeds 102. In such an embodiment the feed reader may be configured to receive descriptive tags and apply them to the URL of the feed 102. In another embodiment an online website may be configured to receive the URL of the feed 102 as well as a descriptive tag. In any case, the input of the tag may be explicitly typed or offered as a checkbox, button or other user interface in the tagging module 404.

The subject matter of the individual feeds 102 making up the aggregated feed 112 is identified by the tags associated with the feeds 102 according to the feed tag protocol 116. Thus, in certain embodiments, when an aggregated feed 112 is requested by a client 104, the aggregation module 110 identifies the feeds 102 that satisfy the aggregated feed request 124 and creates an aggregated feed 112 from the individual feeds 102. The aggregated feed 112 may then be returned to the client 104 requesting that particular aggregated feed 112 as illustrated by line 122. By associating the tag with the feed 102, the aggregated feed 112 may be dynamically updated every time an aggregated feed request 124 is received. No further development or defining of the aggregated feed 112 is required as a single aggregated feed request 124 will return an aggregated feed 112 containing all feeds 102 tagged with that particular tag.

FIG. 2 illustrates one embodiment of the collaboration module 118 configured to define the collaboration group 120. The collaboration module 118 identifies at least one predefined characteristic 206 for defining membership in the collaboration group 120. The predefined characteristic 206 is a characteristic required to become a member of the collaboration group 120. In one embodiment the predefined characteristic 206 may include any characteristic considered desirable for participation in system 100. In certain embodiments the predefined characteristic 206 may include membership in a real-world or virtual group, club or other social network, friendship, business relationship or other association with at least one other member of the collaboration group 120, passing a test designed to illustrate knowledge of a subject, or any other characteristic considered desirable for participation in system 100. For example, in certain embodiments the collaboration module 118 may identify expertise in a particular subject matter area as the characteristic for defining membership in the collaboration group 120. In other embodiments membership in the collaboration group 120 is defined by an interest in a particular subject matter. In that case, anyone with an interest in a particular subject matter may become members 204 of the collaboration group 120.

In the embodiment illustrated in FIG. 2 the predefined characteristic 206 upon which membership in the collaboration group 120 is conditioned is expertise in a subject matter. The collaboration module 118 analyzes the expertise of User A 202A, User B 202B, and User C 202C to identify whether each User 202A-202C (generally 202) is an expert in the subject matter of interest. User A 202A and User B 202B are identified by the collaboration module 118 as having sufficient expertise to be a member of the collaboration group 120. As discussed below, in certain embodiments only members 204 of the collaboration group can tag feeds 102 with feed tags. In other embodiments any individual using system 100 is allowed to tag feeds 102. Thus, in certain embodiments the predefined characteristics 206 may be use of the system 100.

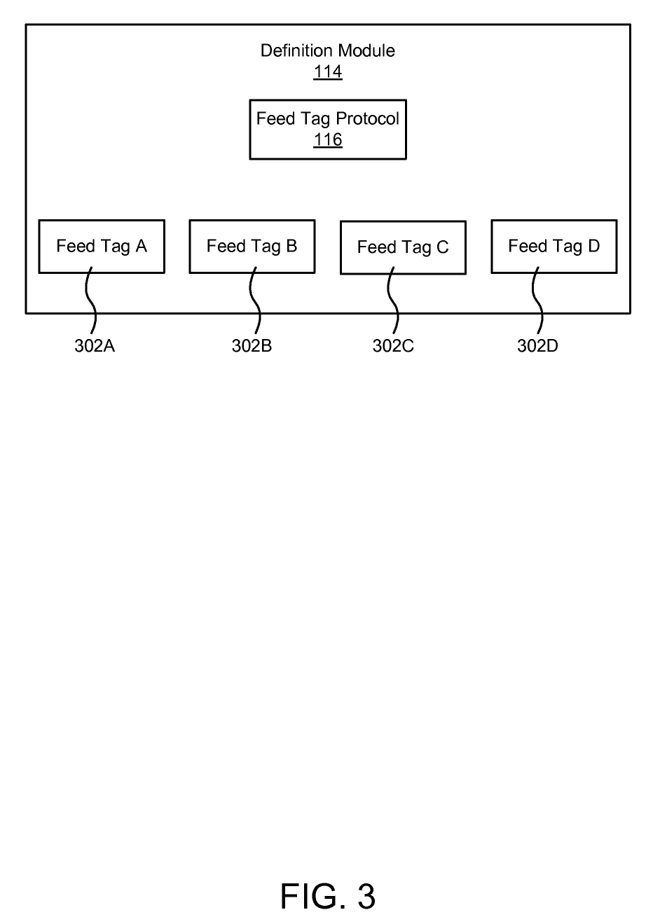

FIG. 3 illustrates one embodiment of the definition module 114 configured to define a feed tag protocol 116. In certain embodiments the feed tag protocol 116 is a set of one or more predefined feed tags 302A-302D (generally 302) identifying aspects of a common subject matter. Examples of tagging protocol 116 may include use of acronyms, synonyms, antonyms or other grammatical identifiers to identify the subject matter of the content items that make up the feed 102. The predefined feed tags 302 include a set of tags having preselected words or phrases that members of the collaboration group 120 use to identify the subject matter of a feed 102 or individual content item of a feed 102. The predefined feed tags 302 are used to tag feeds 102. In other embodiments, the feed tag protocol 116 is a set of tagging rules that members of the collaboration group 120 agree to follow. One example of a tagging rule may be that the aggregated feed 112 comprises all known feeds authored by a particular author. For example, all feeds authored by corporation ABC, Inc.

FIG. 4 illustrates one embodiment of a client 104 including a feed read module 402, a tagging module 404, and a filtering module 406. In certain embodiments the client 104 includes an electronic device capable of interfacing either directly or indirectly with the network 108 and configured to access and read a feed 102 or website. The feed read module 402 may comprise a feed reading device such as an RSS or ATOM feed reader. The feed read module 402 on the client 104 gathers feed content from a plurality of sources and organizes and presents that feed content to a user.

In one embodiment, the feed read module 402 sends an aggregated feed request 124 to the aggregation module 110 and the aggregation module 110 returns the single aggregated feed 112. Those of skill in the art recognize that in certain embodiments, the feed read module 402 may include the functionality of the aggregation module 110 such that the feed read module 402 dynamically gathers feeds 102 and organizes and presents the content of the feeds 102 to the user in a single aggregated feed 112. In certain embodiments the feed read module 402 communicates the aggregated feed request 124 to the aggregation module 110 and receives a single aggregated feed 112 such that the single aggregated feed 112 incorporates feeds 102 tagged by members of the collaboration group 120 since the last aggregated feed request 124. Thus, in certain embodiments the feed read module 402 dynamically updates the single aggregated feed 112 by communicating with the aggregation module 110 each time an aggregated feed request 124 is received from a user. In this manner, the most current set of feeds 102 are included in the single aggregated feed 112. One of skill in the art will recognize that in certain embodiments the feed read module 402 may be configured to automatically periodically request the single aggregate feed 112 without first receiving an aggregated feed request 124 from a user.

The feed read module 402 may comprise completely hardware, completely software or a combination of hardware and software that stores, displays, and/or references items of feeds 102. Examples of a feed read module 402 may include but are not limited to an internet browser, and internet browser plugin, email or feed reading clients such as Microsoft Outlook, and/or other feed display software on a personal computer or a handheld device. In one embodiment, the feed read module 402 may comprise a software web browser such as Internet Explorer or Mozilla Firefox capable of displaying/playing digital feeds 102.

The tagging module 404 associates a feed tag 302 with a feed 102. In one embodiment the feed tag 302 is associated with a URL identifying the location of feeds 102. The URL of the feed 102 and the feed tag 302 may then be stored together in one or more records of a database. The URL identifying the location of the feed 102 and the feed tag 302 may be stored in separate databases or separate locations within a single database. In one embodiment, the database storing the associations of feed tags 302 and feeds 102 is accessible to the aggregation module 110.

In addition, the tagging module 404 allows users of the system 100 to add feed tags 302 to individual feeds 102. The feed tags 302 identify the subject matter of the feeds 102. In certain embodiments, a single feed tag 302 identifies a feed 102. Alternatively, or in another embodiment, a set of feed tags 302 identifies a feed 102. In certain embodiments, the feed tags 302 identify a single aspect of the subject matter of the feed 102. In other embodiments the feed tags 302 may identify a broader subject of the entire feed 102.

The tagging module 404 may comprise an internet browser plugin configured allow a user to add tags 302 to RSS or ATOM feeds 102. Advantageously, so long as a user tags 302 a feed 102 in accordance with the feed tag protocol 116, that tagged feed 102 will automatically be included in the aggregated feed 112 for that feed tag protocol 116.

In certain embodiments, the client 104 includes a filtering module 406. The filtering module 406 filters feeds 102 and/or feed content items according to a user defined filter request. With a user defined filter request, the filtering module 406 returns only those content items and/or feeds included within the single aggregated feed 112 that satisfy the users request. Thus, in certain embodiments the filtering module 406 narrows the results within the single aggregated feed 112 which are returned to the feed read module 402 for display or rendering.

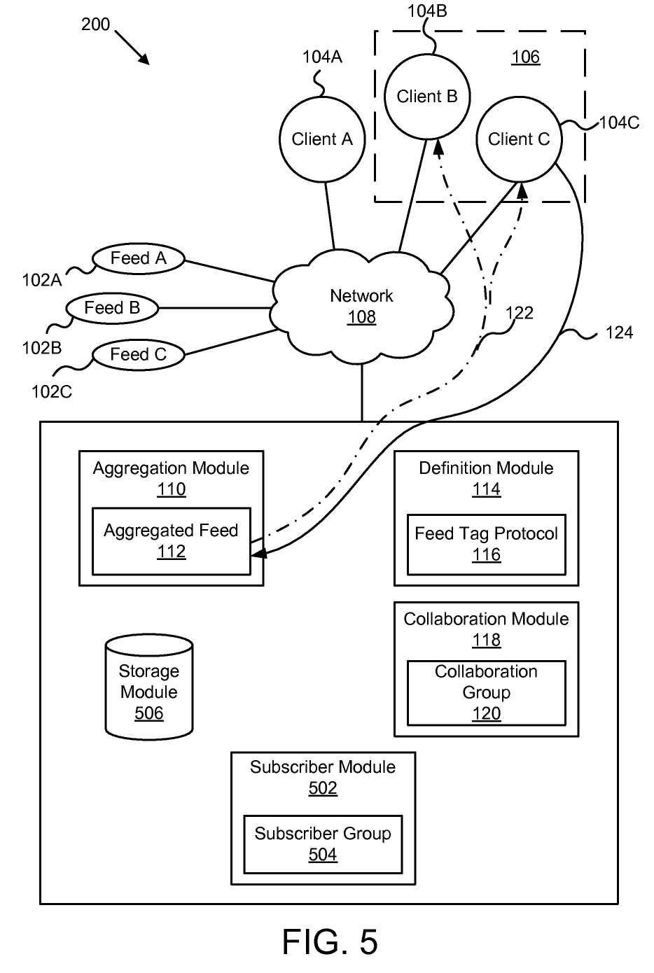

FIG. 5 illustrates one embodiment of a system 200 for aggregating a plurality of web feeds 102A-102C according to one embodiment of the current invention. The system 200 includes a plurality of clients 104A-104C, an online relationship 106 between clients 104B-104C, network 108, aggregation module 110, aggregated feed 112, definition module 114, feed tag protocol 116, collaboration module 118 and collaboration group 120. The web feeds 102A-102C, online relationship 106, clients 104A-104C, network 108, aggregation module 110, aggregated feed 112, definition module 114, feed tag protocol 116, collaboration module 118 and collaboration group 120 operate in substantially the same manner as the corresponding elements of system 100 illustrated in FIGS. 1-4 and discussed above.

System 200 also includes a subscriber module 502, a subscriber group 504, and a storage module 506. The subscriber module 502 receives subscriptions to an aggregated feed 112 and defines a subscriber group 504 of users who have access to the aggregated feed 112. In one embodiment, when the subscriber module 502 receives a request for a new subscription to a particular feed 102 the subscriber module 502 bills the user for a new subscription and, upon receipt of a subscription fee, adds the user to a database or list of paid subscribers. In certain embodiment the subscriber module 502 is configured to bill the subscribers on an incremental basis. In certain embodiments users of the subscriber group 504 have an online relationship 106 or are members of the same online social network. In one embodiment, the users comprising the subscriber group 504 are substantially different from members 204 of the collaboration group 120 such that no user of the subscriber group 504 is also a member of the collaboration group 120. In another embodiment at least some of the users comprising the subscriber group 504 are also members of the collaboration group 120. In one embodiment the users that make up the subscriber group 504 and the members 204 of the collaboration group 120 are substantially the same individuals such that there is no distinction between the two groups.

The storage module 506 of system 200 is configured to store the associations between the feeds 102 and the feed tags 302 of the feed tag protocol 116 in a storage module 506. In certain embodiments the aggregation module 110 is configured to add the feed 102 to the aggregated feed 112 upon the creation of the association between the feed 102 and the feed tag 302. In another embodiment the storage module 506 stores the association between the feed 102 and the feed tag 302 and the aggregation module 110 creates the aggregated feed 112 only when a subsequent aggregated feed request 124 is received by the aggregation module 110.

The aggregation module 110 has access to the storage module 506 containing the associations between the feeds 102 and the feed tags 302. When a user of clients 104 submits an aggregated feed request 124 to the aggregation module 110 the aggregation module 110 accesses the storage module 506. The associations stored on the storage module 506 are reviewed to identify feed tags 302 satisfying the aggregated feed request 124. The feeds 102 associated with the feed tags 302 identified as satisfying the aggregated feed request 124 are aggregated into aggregated feed 112. The aggregated feed 112 is then returned to the user at one of the clients 104 as illustrated by line 122.

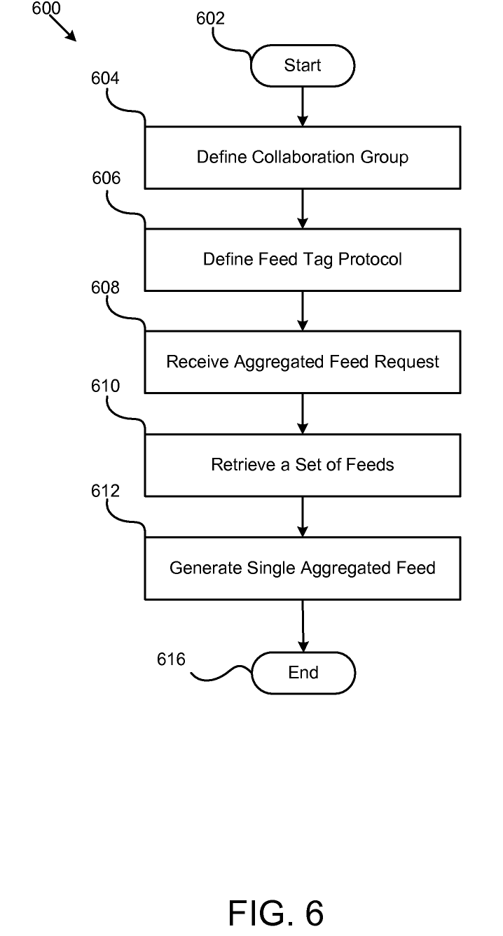

FIG. 6 illustrates one embodiment of a method for aggregating a plurality of feeds. The method starts 602 by the collaboration module 118 defining 604 a collaboration group 120. Next, the definition module 114 defines 606 a feed tag protocol 116 which members 204 of the collaboration group 120 agree to follow. An aggregation module 110 receives 608 an aggregated feed request 124 and retrieves 610 a set of feeds 102 satisfying the aggregated feed request 124. The aggregation module 110 generates 612 an aggregated feed 112 from the set of feeds retrieved and the method ends 616.

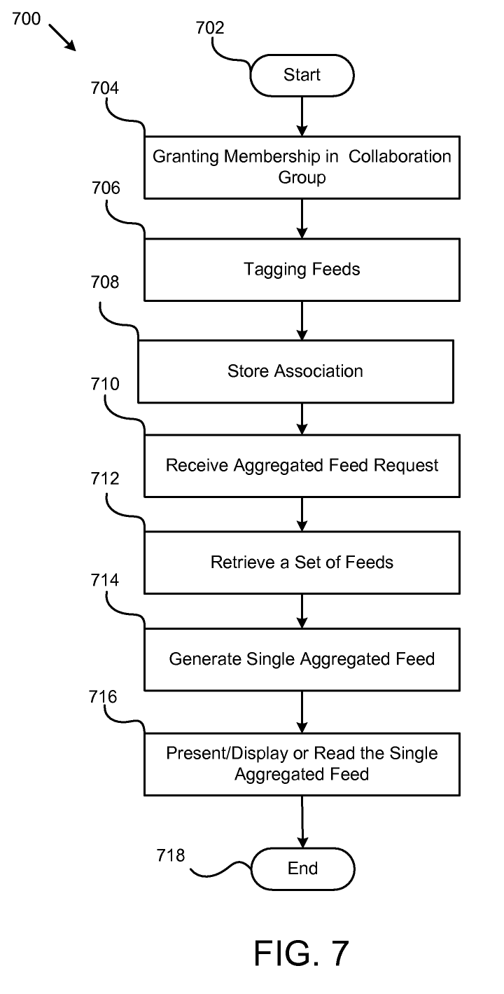

FIG. 7 illustrates another embodiment of a method for aggregating a plurality of feeds 102. The method starts 702 by granting 704 membership in a collaboration group. In certain embodiments, membership in the collaboration group 120 is only granted 704 to members 204 having a predefined characteristic 206. In one embodiment the predefined characteristic 206 is expertise as defined by satisfying certain criteria relating to a particular subject matter. The members 204 of the collaboration group 120 use the tagging module 404 to mark or tag 706 feeds 102 with feed tags 302 that satisfy the feed tag protocol 116. The storage module 506 stores 708 the association created by the tagging 706 of the feeds 102 with the feed tags 302. The aggregation module 110 receives 710 an aggregated feed request 124 and retrieves 712 a set of feeds 102 associated with the particular aggregated feed request 124 by referring to the stored associations of feeds 102 and feed tags 302. The aggregation module 110 generates 714 a single aggregated feed 112 from the set of feeds 102. The feed read module 402 presents, displays, plays, or reads 716 the single aggregated feed 112 and the method ends 718.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for aggregating a plurality of web feed sources, the method comprising:
defining a collaboration group of one or more members each having an online relationship to each other;
defining a feed tag protocol that members of the collaboration group agree to follow for marking feeds; and
receiving an aggregated feed request and retrieving a set of feeds tagged by members of the collaboration group that satisfy the feed tag protocol and generating a single aggregated feed based on the set of feeds retrieved, the single aggregated feed defined by a set of tags that satisfy the feed tag protocol.

2. The method of claim 1, wherein the single aggregated feed incorporates feeds tagged by members of the collaboration group since a last aggregated feed request.

3. The method of claim 1, further comprising granting membership in the collaboration group, wherein membership in the collaboration group is conditioned upon a member having one or more predefined characteristics.

4. The method of claim 3, wherein the predefined characteristic comprises the member belonging to an online social network that includes other members of the collaboration group.

5. The method of claim 1, further comprising defining a subscriber group of users subscribing to the single aggregated feed and managing subscriptions for users of the subscriber group.

6. The method of claim 5, wherein users of the subscriber group belong to the same online social network.

7. The method of claim 1, further comprising associating a feed tag with a feed identified by a member of the collaboration group, the feed tag assigned by the member in accordance with the feed tag protocol.

8. The method of claim 1, further comprising storing an association between the feed and the feed tag in a database for retrieval in response to a subsequent aggregated feed request.

9. The method of claim 1, further comprising defining a set of tags for the feed tag protocol and one or more relationships between tags in the set of tags.

10. The method of claim 9, wherein each tag comprises a single text word describing content of an associated feed.

11. The method of claim 9, wherein the one or more relationships comprises one or more of a hierarchical relationship, a set membership relationship, and a grammatical relationship.

12. The method of claim 1, further comprising filtering content items from the single aggregated feed according to user-defined filter criteria such that a user interface displays only the content items satisfying the user-defined criteria.

13. A computer program product comprising a computer readable medium having computer usable program code executable to perform operations for aggregating a plurality of web feed sources, the operations of the computer program product comprising:
defining a collaboration group of one or more members, each member having an online relationship to each other;
defining a feed tag protocol that members of the collaboration group have agreed to follow for marking feeds;
receiving an aggregated feed request;
retrieving a set of feeds tagged by members of the collaboration group that satisfy the aggregated feed request; and
generating a single aggregated feed based on the set of feeds, the single aggregated feed defined by a set of tags that satisfy the feed tag protocol.

14. The computer program product of claim 13, wherein the operations of the computer program product further comprise updating the single aggregated feed to incorporate feeds tagged by members of the collaboration group since a last aggregated feed request.

15. The computer program product of claim 13, wherein the operations of the computer program product further comprise granting membership in the collaboration group, wherein membership in the collaboration group is conditioned upon a member having one or more predefined characteristics.

16. The computer program product of claim 13, wherein the operations of the computer program product further comprise managing a subscriber group of users subscribing to the single aggregated feed.

17. The computer program product of claim 13, wherein the operations of the computer program product further comprise associating a feed tag with a feed identified by a member of the collaboration group, the feed tag assigned by the member in accordance with the feed tag protocol.

18. The computer program product of claim 13, wherein the operations of the computer program product further comprise storing an association between the feed and the feed tag in a database such that the aggregation module retrieves the feed in response to a subsequent aggregated feed request.

19. A system for aggregating a plurality of web feed sources, the system comprising:
a network configured to communicate data between a plurality of devices;
a client in communication with the network, the client comprising a feed tagging module configured to associate a feed tag with a feed identified by a member of a collaboration group, the feed tag assigned by the member in accordance with a feed tag protocol; and
a server in communication with the network, the server comprising:
a collaboration module configured to define the collaboration group of one or more members each having an online relationship to each other;
a definition module configured to define the feed tag protocol that members of the collaboration group agree to follow for marking feeds;
an aggregation module configured to receive an aggregated feed request, and to retrieve a set of feeds tagged by members of the collaboration group that satisfy the aggregated feed request and further configured to generate a single aggregated feed based on the set of feeds, the single aggregated feed defined by a set of tags that satisfy the feed tag protocol; and
a feed read module configured to read the single aggregated feed in response to an aggregated feed request from a user.

20. The system of claim 19, wherein the server further comprises a storage module configured to store the association between the feed and the feed tag created by the feed tagging module in a database such that the aggregation module retrieves the feed in response to a subsequent aggregated feed request.

21. An apparatus to aggregate a plurality of web feed sources, the apparatus comprising:
a collaboration module configured to define a collaboration group of one or more members each having an online relationship to each other;
a definition module configured to define a feed tag protocol that members of the collaboration group agree to follow for marking feeds; and
an aggregation module configured to receive an aggregated feed request, and to retrieve a set of feeds tagged by members of the collaboration group that satisfy the feed tag protocol and further configured to generate a single aggregated feed based on the set of feeds retrieved, the single aggregated feed defined by a set of tags that satisfy the feed tag protocol.
